(19) United States
(12) Patent Application Publication
(10) Pub. No.: US 2017/0046682 A1
(43) Pub. Date: Feb. 16, 2017

(54) REAL-TIME MOBILE PAYMENT PROCESSING SYSTEM

(71) Applicant: Intel Corporation, Santa Clara, CA (US)

(72) Inventors: Gyan Prakash, Beaverton, OR (US); Selim Aissi, Menlo Park, CA (US); Saurabh Dadu, Tigard, OR (US); Ramesh Pendakur, Gaston, OR (US); Mojtaba Mirashrafi, Portland, OR (US)

(21) Appl. No.: 15/157,039

(22) Filed: May 17, 2016

Related U.S. Application Data
(63) Continuation of application No. 12/978,134, filed on Dec. 23, 2010, now abandoned.

(51) Int. Cl. G06Q 20/32; G06Q 30/06; G06Q 20/40; G06Q 20/04

(52) U.S. Cl. CPC G06Q 20/3223; G06Q 20/0453; G06Q 30/0633; G06Q 20/4014; G06Q 20/4016

(57) ABSTRACT

A method, system, and device are disclosed. In one embodiment the method includes receiving a recipient phone number into an electronic gift phone module (EGPM). The EGPM also receives a set of gift data that includes a gift identification. The EGPM sends the recipient phone number and at least some gift data to an electronic gift processing server module (EGPSM). The EGPSM purchases a recipient gift by utilizing the gift identification. The EGPSM also sends notification of the recipient gift purchase to the recipient phone number.

### CROSS-REFERENCE TO RELATED APPLICATIONS

This application is a continuation application of U.S. application Ser. No. 12/978,134, entitled “Real-Time Mobile Payment Processing System,” which was filed on Dec. 23, 2010.

### FIELD OF THE INVENTION

The invention relates to processing payments of electronic gifts over a network.

### BACKGROUND

With the growing adoption of smart phones as social networking devices and as the defacto handheld computing device, there are many opportunities in providing services that leverage the always-on/always-connected smart phone computing device. Services that cost money generally involve payments through financial institutions and banks. This adds a level of security risk to a transaction for services as well as a layer of complexity.

### BRIEF DESCRIPTION OF THE DRAWINGS

The present invention is illustrated by way of example and is not limited by the drawings, in which like references indicate similar elements, and in which:

FIG. 1 illustrates an embodiment of a group of computing devices capable of implementing a real-time mobile payment system.

FIG. 2 describes an embodiment of the major components within each computing device in the real-time mobile payment system.

FIG. 3 illustrates a more detailed embodiment of one or more of the computing devices in the real-time mobile payment system.

FIG. 4 is a flow diagram of an embodiment of a process to implement a real-time mobile payment system over a network.

### DETAILED DESCRIPTION OF THE DRAWINGS

Elements of a method, system, and device to implement a real-time mobile [0010) payment system are disclosed.

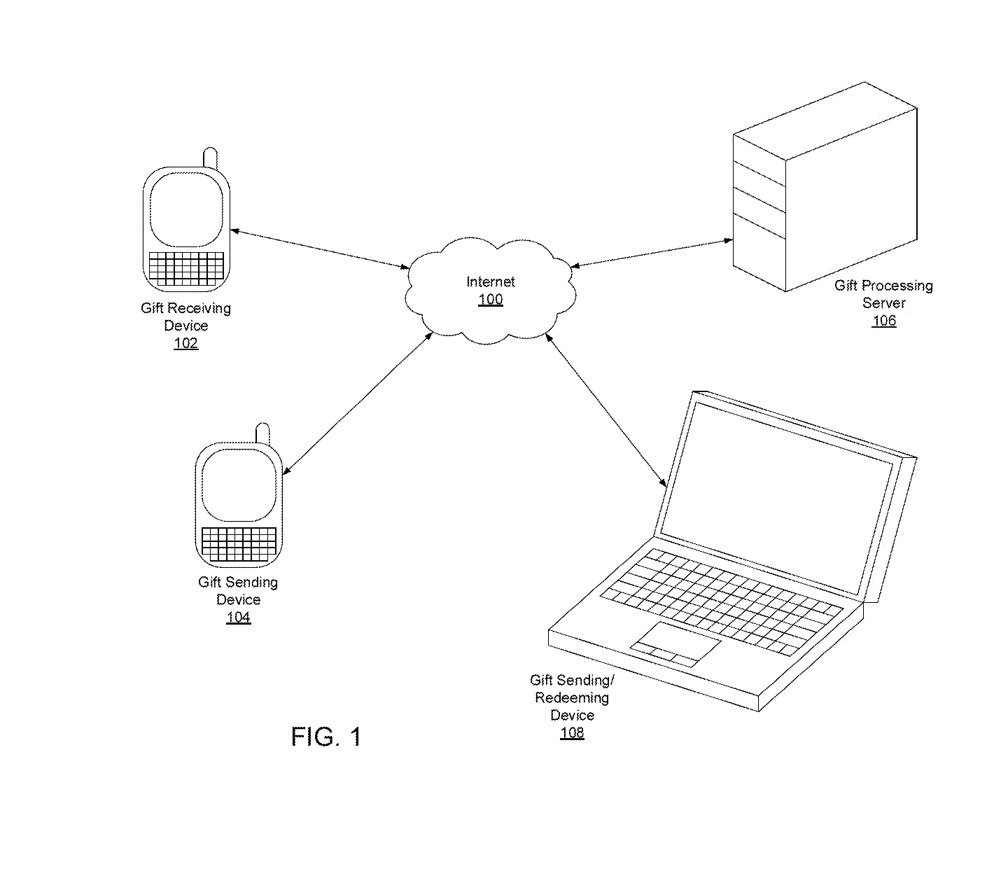

FIG. 1 illustrates an embodiment of a group of computing devices capable of implementing a real-time mobile payment system.

Electronic gifts sent across networks may take several forms, but a common form is a gift card to one or more retail establishments, which the gift receiver may use to purchase goods. A gift card may be to a specific retail establishment or it may be a more generic credit card or similarly-based generic gift card that can be used to purchase goods from any store that accepts the credit card.

In many embodiments, the computing devices are communicatively coupled to each other over one or more networks, such as the Internet 100. For example, the computing devices may communicate with each other over several different networks that are all coupled to each other through the Internet. Each computing device in the group may connect to the Internet utilizing a unique Internet provider or two or more of the devices may use the same Internet provider. The computing devices making up the group may take several forms. A cellular smart phone, a laptop computer, a desktop computer, a television set top computer or gaming system, a workstation, or a server are among the many types of computing devices that may communicate over the Internet or through one or more other networks.

Generally, there are at least three main devices that are utilized to create the real-time mobile payment system: the gift receiving device 102, the gift sending device 104, and a gift processing server device 106. In many embodiments, the gift receiving device 102 is a type of cellular phone because a gift is sent in the form of an electronic gift card to a target telephone number. The gift sending device 104 may also be a cellular phone, but that is not necessary because a gift sending software application may be loaded onto a laptop, desktop, or other type of computer system. In many embodiments, the gift sending software application is a web-based application. With a web-based application, any type of computing device that accesses the Internet may be capable of having the job of the gift sending device. For example, gift sending device 108, which is a laptop computer instead of a cellular phone, may have the gift sending application installed as well and could just as easily be the gift sending device utilized. Therefore, the gift sending device may be any device shown in FIG. 1, although in the example shown device 104 is the sending device. In other words, device 102 that is receiving the gift in the example, may be sending a gift using the same process in another embodiment that is not shown.

The gift sending device 104, having the gift sending application on it, generally allows a user to initiate the gift-sending application. The gift sending application may allow the user to browse a number of websites of retail establishments that allow purchases via electronic gift cards. When the type of gift card has been determined, the gift sending application contacts the gift processing server 106. The gift processing server 106 receives the electronic gift card purchasing request. The gift processing server 106 may receive payment directly from the gift sending application. Payment may be in the form of charging a credit card, charging a money-exchanging electronic account such as PayPal®, or potentially putting a charge on the monthly service bill of the gift sending device 104. For example, when the gift sending device is a cellular phone, the gift processing server 106 may charge the electronic gift card purchase amount to the cellular phone bill of the gift sending device 104.

In many embodiments, the gift sending device 104 sends a set of gift data to the gift processing server 106. The set of gift data may include the type of electronic gift card to purchase (essentially the identification of the gift), an amount of money to fund the electronic gift card, the payment information to pay for the purchase of the electronic gift card, as well as the gift recipient's phone number to provide the gift processing server the means by which it may gain contact with the gift receiving device 102. This set of gift data may be sent in one or more data packets across Internet 100 from the gift sending device 104 to the gift processing server 106.

The gift processing server 106, once it has received payment information of the gift purchase, may complete the purchase transaction by contacting the requisite retail establishment and purchasing the electronic gift card. In some embodiments, the gift processing server 106 performs an intermediary transaction where it first receives payment in full for the purchase from the gift sending device 104 and then after it has the money, contacts a retail establishment electronically (e.g., through their website) to buy the electronic gift card. In other embodiments, the gift processing server 106 does not perform an intermediary transaction of receiving payment prior to purchasing the electronic gift card, but instead simply facilitates the electronic gift card purchase transaction between the gift sending device and the retail establishment.

When the gift processing server 106 performs the intermediate purchase, there are essentially two monetary transactions taking place: 1) gift sending device 104 paying gift processing server 106, and 2) subsequently gift processing server 106 paying the retail establishment for the electronic gift card. When the there is no intermediate purchase, the gift processing server 106 receives the credit card information from the gift sending device 104 and provides that information to the retail establishment for a direct electronic gift card purchase. Thus, in the second example, the retail establishment directly charges the electronic gift card cost on the user's credit card. Apart from the base cost of the electronic gift card purchase, the gift processing server 106 may also charge the gift processing convenience fee to the gift sending device 104. This convenience fee may be tacked onto the credit card payment amount or it might be charged separately utilizing the phone bill of the gift sending device 104 (in the embodiments where device 104 is a phone). For example, in these embodiments where device 104 is a phone, the convenience fee may be similar to the cost a cell phone user pays when dialing directory assistance.

Once the purchase of the electronic gift card is complete and the gift processing server receives the electronic gift card information for use, the gift processing server 106 may initiate a notification to the gift receiving device 102. In some embodiments, the notification may be in the form of an SMS text message, which may include a link to the retail establishments website to redeem the electronic gift card. In other embodiments, the notification may be in the form of an automated voice call to the gift receiving device 102 instructing the user of device 102 to perform certain instructions to redeem the electronic gift card. In yet other embodiments, the notification may be in the form of an email sent to an email service that can be received by an email application on the gift receiving device 102.

The gift processing server 106, once the purchase of the electronic gift card is complete, may send the gift sending device 104 notification that the electronic gift card purchase completed successfully. The notification may take the form of an electronic receipt breaking down the costs associated with the purchase and a verification of the form of payment and amount of payment utilized. In different embodiments, the notification may be a an SMS text message, email, or automated voice mail stating the purchase completed successfully. In yet other embodiments, the gift sending application may include a graphical interface that dynamically updates the status of any outstanding electronic gift receipt purchase.

The gift receiving device 102 may include a gift receiving application that activates when notification arrives from the gift processing server 106 about a received gift. The gift receiving application may request acknowledgement from the user of gift receiving device 102 that the gift notification was received. Acknowledgement from the gift receiving device 102 may be in one of the same SMS/voice/email electronic communication forms discussed above. In many embodiments, the gift receiver device 102 may be sent reminders one or more times to comply with the acknowledgement of the electronic gift card. The gift receiving application may also include a graphical interface where acknowledgement is simply a single button click. Once the user acknowledges receipt, the acknowledgement notification may then be sent back to the gift processing server 106, which, in turn, may pass the acknowledgement on to the gift sending device 104. This acknowledgement notification may take the same form as the previous acknowledgement notification regarding the purchase (i.e., through a text message, through a visual notification in the gift sending application's graphical interface, etc.).

The electronic gift card may provide a link to the retail establishment's website and a password to access the gift card amount. This information may be sent to any given device coupled to Internet 100. Thus, it may be capable to redeem/utilize the electronic gift card on any device coupled to the Internet 100. The only limitation would be the receiving user's ability to browse for goods he/she would care to purchase by utilizing the gift card. Thus, although the receiving the device receives the electronic gift card, the user may want to delay utilizing the gift card until he/she has access to another device, such as device 108. Reasons for utilizing a secondary device to redeem the gift may be due to the gift-receiving device being a low-end mobile phone that does not have the capability to adequately redeem the gift. If the gift receiving device 102 is capable it can redeem the gift or the gift receiving device 102 may send the electronic gift card information to the gift redeeming device 108 to redeem the gift.

In other embodiments, the set of gift data sent from the gift sending device 104 to the gift processing server 106 may also include data to specify whether the gift processing server 106 will track the use of the purchased electronic gift card. In some embodiments, the electronic gift card usage may be tracked by the retail establishment and this data may be sent to the gift processing server 106 upon request. Thus, the gift processing server 106 may notify the gift sending device 104 when the electronic gift card is utilized for a purchase, how much that purchase is for, as well as how much is remaining on the gift card. In some embodiments, this may act like a gift subscription, where the purchaser of the gift is informed when the gift is about to run out. This would allow the purchaser to purchase more funds to put on the electronic gift card prior to the card becoming empty of funds.

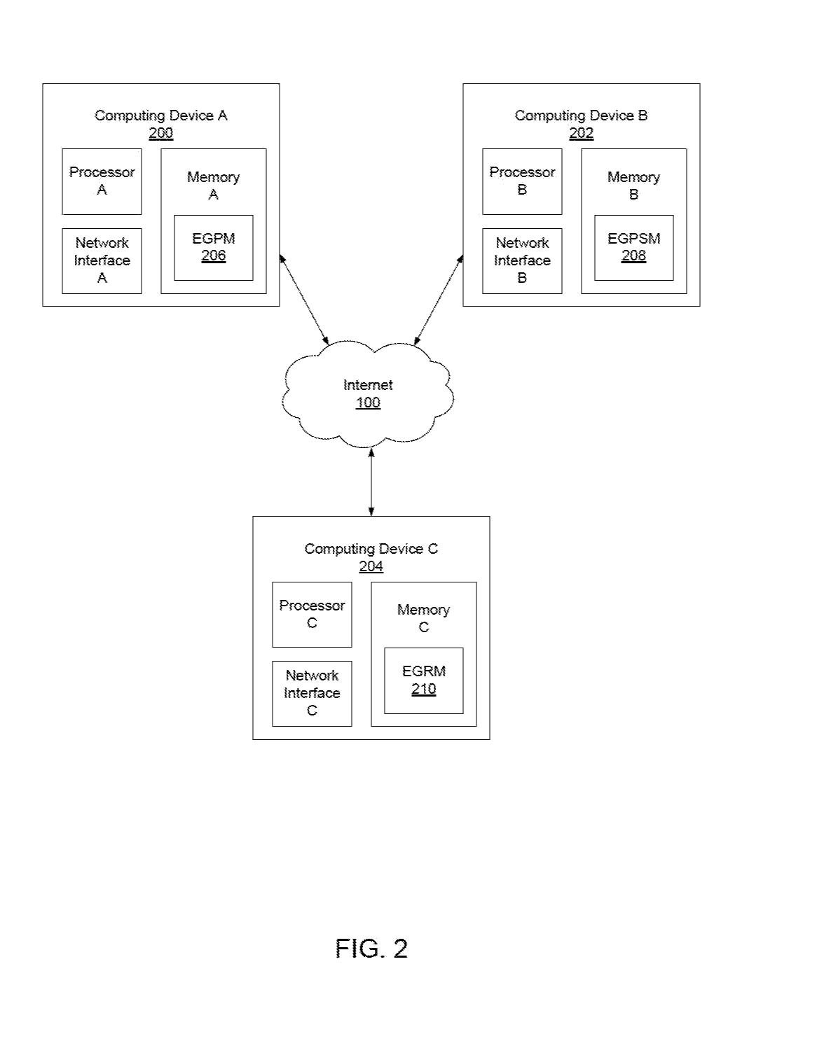

FIG. 2 describes an embodiment of the major components within each computing device in the real-time mobile payment system.

Computing devices A, B, and C (200, 202, and 204, respectively) are shown. Each computing device includes at least a processor, a memory to store an operating system and software applications that the processor executes, and a network interface to provide a communication between the computing device and other computing devices communicatively coupled to the Internet 100. The network interface may be different on different devices. For example, the network interface on a cellular phone may be coupled to an antenna for receiving and transmitting signals across the cellular network, while the network interface on a server may couple the server to a local network by an Ethernet cable. These separate networks may all be coupled generally to the Internet 100. Thus, although devices A-D in FIG. 2 may communicate over networks using different protocols and transmission methods, each may be indirectly coupled to the Internet 100, which in turn, allows them to communicate with each other.

Computing device A 200 includes at least an electronic gift phone module (EGPM) 206. The EGPM 206 may reside on the gift sending device (104 in FIG. 1). The EGPM 206 initiates the gift process by sending the gift processing server the following information:

Gift receiver's phone number

Type of gift card

Date of sending the gift card

Amount of electronic gift to fund the card, and

Type of acknowledgement

This information listed may be referred to as a set of gift data generally sent from the gift sending device to the gift processing server. The gift receiver's phone number allows phone-based communication that facilitates sending the gift to the gift receiver device. The type of gift card includes identification of the retail establishment to purchase the gift card from. The date of sending the gift card allows for a delay between the purchase of the gift card and sending it to the gift receiver device (e.g., the sender wants the gift to arrive on the receiver's birthday). The amount of the electronic gift to fund the card specifies the monetary amount to put on the electronic gift card. Finally, the type of acknowledgement refers to the whether a simple notification of the receipt of the gift card by the gift receiving device is sufficient or whether additional notifications are to be received based on whether the card was used or not.

Computing device B 202 includes at least an electronic gift processing server module (EGPSM) 208. The EGPSM 208 may reside on the gift processing server (106 in FIG. 1), thus computing device B 202 may be a server. The EGPSM 208 purchases the electronic gift on behalf of the sender, the server can either bill directly to the gift sending device's monthly bill (as long as the sending device is a telephone), or can charge to the sender's credit card, as discussed above. The EGPSM 208 may keep track of usage of the gift card when requested by the gift sending device. Finally, the EGPSM 208 sends the gift notification to the gift receiving device and also acknowledgement of the purchase (and potentially receipt) of the gift by the gift receiving device.

Computing device C 204 corresponds to gift receiving device (102 in FIG. 1). This computing device may include an electronic gift receiver module (EGRM) 210. The EGRM 210 is optional and works with low-end mobile phones which may not have the ability to run a gift application. This may be because of limitations in processing, in the operating system, security, etc. The EGRM allows the gift receiver user to retrieve the gift information using a web interface and also authenticates the user with credentials such as a password that is provided with the received electronic gift card notification message.

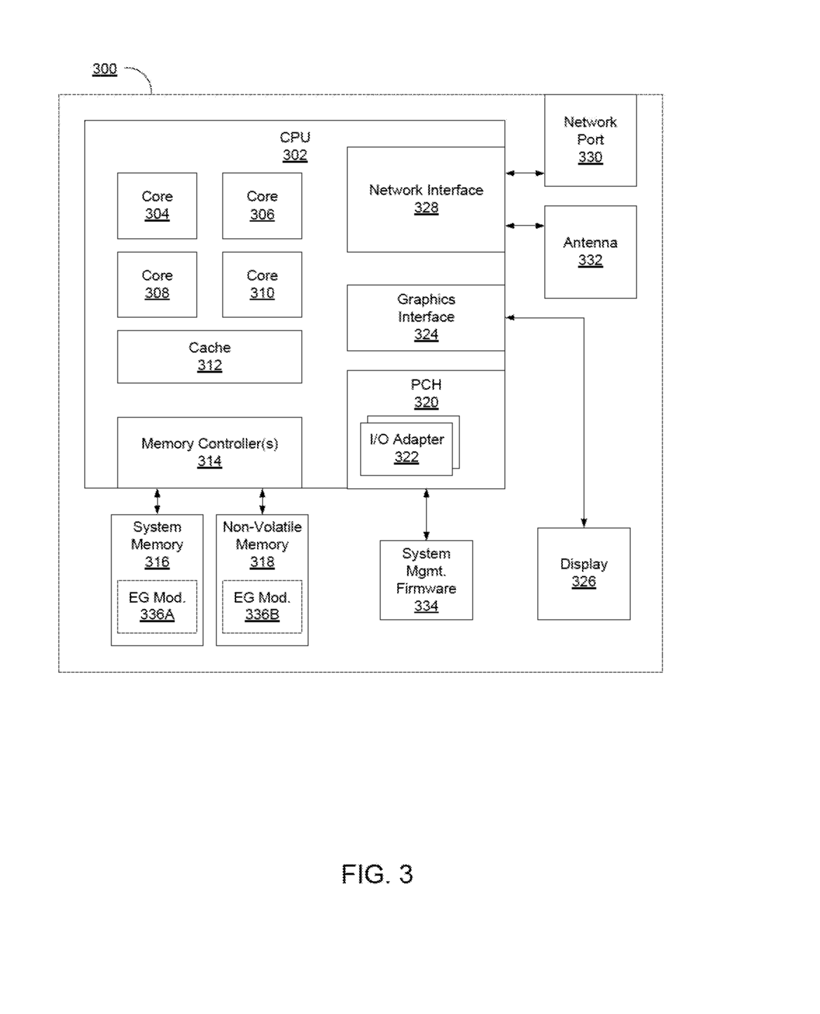

FIG. 3 illustrates a more detailed embodiment of one or more of the computing devices in the real-time mobile payment system.

Although the computing device shown in FIG. 3 may comprise a high-end smart phone Each computing device (A, B, and C) in FIG. 2 may include some or all of the components shown in FIG. 3.

Computing device 300 is shown. The computing device may be a desktop, server, workstation, laptop, smartphone, television set-top, media center, game console, integrated system (such as in a car), or other type of computing device. In several embodiments the computing device 300 includes one or more central processing units (CPUs), also referred to as “processors.” Although in many embodiments there are potentially many CPUs, in the embodiment shown in FIG. 3 only CPU 302 is shown for clarity. CPU 302 may be an Intel® Corporation CPU or a CPU of another brand. CPU 302 includes one or more cores in different embodiments. CPU 302 is shown including four cores (Cores 304, 306, 308, and 310).

In many embodiments, each core includes internal functional blocks such as one or more execution units, retirement units, a set of general purpose and specific registers, etc. CPU 302 may also include one or more caches, such as cache 312. In many embodiments that are not shown, additional caches other than cache 312 are implemented so that multiple levels of cache exist between the execution units in each core and memory.

In many embodiments, CPU 302 includes one or more integrated memory controllers 314 to provide an interface to communicate with volatile memory 316 and/or non-volatile memory 318. In other embodiments that are not shown, memory controller 314 may be located in a discrete component, separate from CPU 302, elsewhere in computing device 300.

Volatile memory 316 may comprise dynamic random access memory (DRAM), such as a type of double data rate (DDR) DRAM or another form of volatile memory. Non-volatile memory 318 may comprise a flash memory, phase change memory (PCM), or another type of non-volatile memory technology. Volatile memory 316 may be a general purpose memory to store data and instructions to be operated upon by CPU 302. Additionally, there may be other potential devices within computer system 300 that have the capability to read and write to the system memories, such as a direct memory access (DMA)-capable I/O (input/output) device.

The links (i.e., bus, interconnect, etc.) that couple CPU 302 with memories 316 and 318 may include one or more optical, metal, or other wires (i.e. lines) that are capable of transporting data, address, control, and clock information.

Platform controller hub (PCH) 320 (e.g., a complex of I/O controller circuitry) includes an I/O interface that enables communication between the CPU 302 and external I/O devices. The hub may include one or more I/O adapters, such as I/O adapter 322. I/O adapters translate a host communication protocol utilized within the CPU 302 to a protocol compatible with a particular I/O device (not shown). Some of the protocols that a given I/O adapter may translate include a Peripheral Component Interconnect (PCI), Universal Serial Bus (USB), IDE, SCSI, and 1394 “Firewire,” among others. Additionally, there may be one or more wireless protocol I/O adapters. Examples of wireless protocols are Bluetooth, IEEE 802.11-based wireless protocols, and cellular protocols, among others. Apart from I/O devices, the PCH 320 also may be coupled to one or more embedded controllers (ECs) that each may incorporate a number of functions.

In other embodiments, PCH 320 is a discrete device located externally to the CPU 302. In these embodiments, an interface such as a direct memory interface (DMI) couples the CPU to the PCH. Though, these embodiments are not shown.

Graphics interface 324 may provide an interface to a link coupled to a discrete graphics controller (a discrete graphics controller is not shown). The interface may be a high-speed platform component interconnect (PCI)-Express interface or another high-speed interface. In other embodiments, CPU 302 includes an integrated graphics controller and graphics interface 324 may be coupled to a display device 326, such as a monitor. In many embodiments, the interface is high-speed to allow for significant graphical data traffic to be transferred across the link (e.g., 3D graphics, video, etc.).

Network interface 328 may provide an interface to a network through a wired connection (e.g., Ethernet, etc.), coupled to network port 330, or a wireless connection (e.g., cellular telephone network (3G, 4G, etc.), IEEE 802.11 wireless standard, WiMAX, etc.). The wireless connection may utilize an antenna 332 to transmit/receive data over the wireless network.

The computing device 300 also includes a system management firmware 334 to provide boot instructions to initialize the computing device and components. In different embodiments, system management firmware may be a basic input/output system (BIOS), an extendible firmware, or another form of firmware instructions the computing device may utilize during the boot process.

In different embodiments, one or more electronic gift modules (discussed above in regard to FIG. 2) may be stored in one of the memories, such as electronic gift modules 336A and 336B. Depending on the computing device embodiment described in FIG. 3 (i.e., the gift receiving device, the gift sending device, or the gift processing server), the electronic gift module(s) 336A/B may be the EGPM, EGPSM, or EGRM from FIG. 2, or a combination of two or more of those modules.

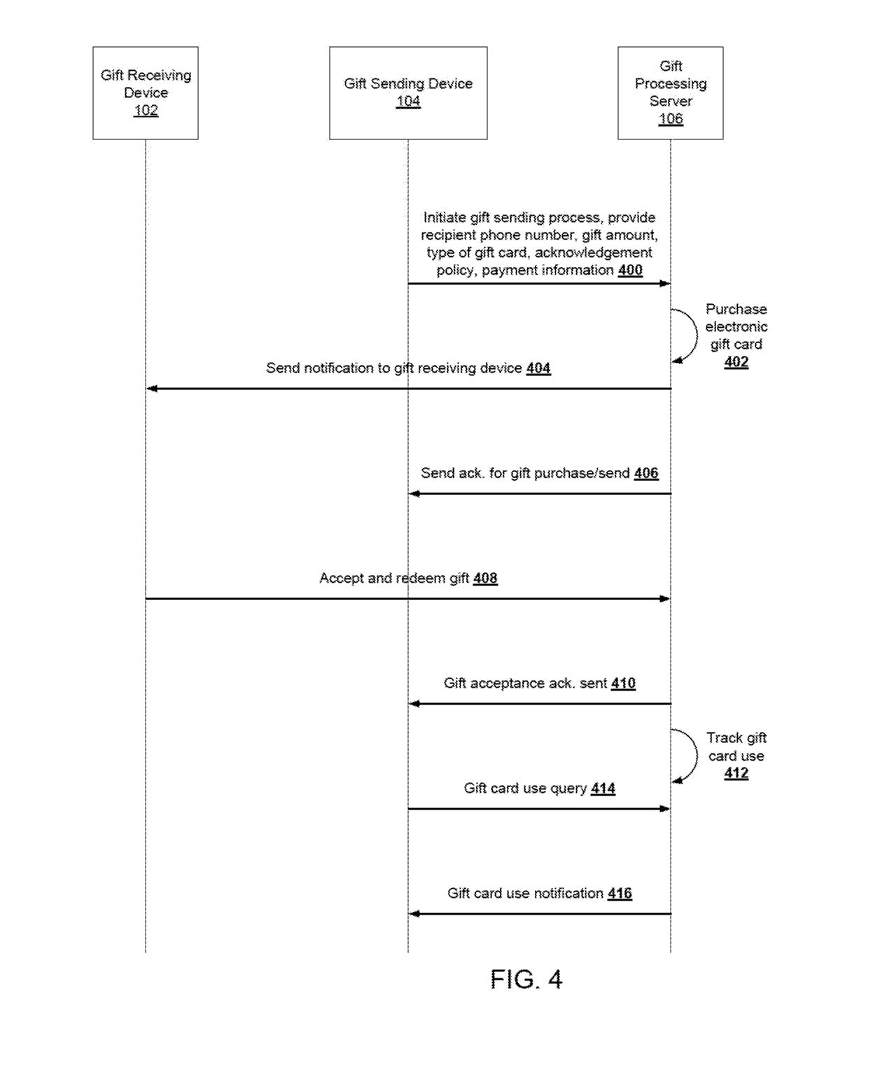

FIG. 4 is a flow diagram of an embodiment of a process to implement a real-time mobile payment system over a network.

The process is performed by processing logic, which may be implemented in hardware circuitry, software programs, firmware code, or a combination of any of the above three forms of logic. The process involves three distinct devices in many embodiments, the gift receiving device (102 from FIG. 1), the gift sending device (104 from FIG. 1), and the gift processing server (106 from FIG. 1). These devices are shown at the top and processing steps that originate from a given device are signified by arrows originating from the vertical dashed lines below each respective device block.

The process begins by processing logic in the gift sending device Initiating the gift sending process by providing the recipient phone number, the gift amount, the type of gift card, the specific gift acknowledgement policy, and the gift payment information to the gift processing server (processing stage 400). As clarified above, this information sent may be viewed as the set of gift data.

Next, processing logic in the gift processing server utilizes the set of gift data received and purchases the electronic gift card (processing stage 402). Then processing logic in the gift processing server sends a gift notification to the gift receiving device (processing stage 404). Additionally, processing logic in the gift processing server sends an acknowledgement to the gift sending device to notify the completion of the gift purchase as well as to notify that the gift was sent to the gift receiving device (processing stage 406).

At a point after the gift receiving device receives notification of the gift, processing logic in the gift receiving device sends an acceptance of the gift and potentially redemption of the gift to the gift processing server (processing stage 408). When the gift acceptance is received, processing logic in the gift processing server sends the gift sending device an acknowledgement that the gift was accepted by the gift receiving device (processing stage 410).

Then, depending on the level of information tracking that the gift sending device requests during the purchase of the gift, processing logic in the gift processing server may track the usage of the electronic gift card over time (processing stage 412). Then, in response to processing logic in the gift sending device querying the usage of the gift card (processing stage 414), processing logic in the gift processing server will respond with a gift card usage notification sent to the gift sending device (processing stage 416) and the process is complete.

Elements of embodiments of the present invention may also be provided as a non-transitory machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions.

In the description above and in the claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate, interact, or communicate with each other.

In the description above, certain terminology is used to describe embodiments of the invention. For example, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

1. A method of purchasing an electronic gift from a gift sending device for a recipient via a gift processing server, the method comprising:
receiving, by an electronic gift phone module (EGPM) of the gift sending device, a phone number corresponding to a mobile computing device of the recipient;
receiving, by the EGPM of the gift sending device, a set of gift data at least including a gift identification, the gift identification comprising a type of an electronic gift to purchase and a retail establishment to purchase the electronic gift from, wherein the electronic gift is capable of being used more than one time; and
sending, by the EGPM the phone number and at least some of the set of gift data, including the gift identification, to an electronic gift processing server module (EGPSM) of the gift processing server to communicate with the retail establishment, purchase the electronic gift from the retail establishment utilizing at least the gift identification, and send a notification of the purchase of the electronic gift to the mobile computing device of the recipient corresponding to the phone number, wherein the notification includes access information usable by the recipient to redeem the gift;
providing, by the EGPM, a usage request of the electronic gift from the EGPSM; and
receiving, by the EGPM, an electronic gift usage notification from the EGPSM indicative of usage of the electronic gift tracked by the EGPSM.

2. The method of claim 1, further comprising:
the EGPM running as an application on a website.

3. The method of claim 1, wherein the mobile computing device corresponding to the phone number is running an electronic gift receiver module (EGRM), the EGRM at least providing a gift retrieval interface to retrieve the electronic gift.

4. The method of claim 3, further comprising:
displaying, by the gift retrieval interface of the EGRM, a notification of receipt of the electronic gift purchase on the mobile computing device;
providing, by the gift retrieval interface, a secure login for the recipient, the secure login authenticating the recipient; and
providing, by the gift retrieval interface, access to the electronic gift sent from the EGPSM upon authenticating the recipient.

5. The method of claim 1, further comprising:
the set of gift data including gift payment type information, wherein the gift payment type information includes one of credit card information and direct phone bill information.

6. The method of claim 1, further comprising:
receiving, by the EGPM of the gift sending device, a confirmation notification of the purchase of the electronic gift from the EGPSM.

7. A device to purchase an electronic gift, the device comprising an electronic gift phone module (EGPM) to:
receive a phone number that corresponds to a mobile computing device of a recipient and a set of gift data that at least includes a gift identification, wherein the gift identification comprises a type of an electronic gift to purchase and a retail establishment to purchase the electronic gift from;
send the phone number and at least a portion of the set of gift data that includes the gift identification to an electronic gift processing server module (EGPSM) of a gift processing server to communicate with the retail establishment, purchase the electronic gift from the retail establishment based at least in part on the gift identification, and send a notification of the purchase of the electronic gift to the mobile computing device of the recipient that corresponds to the phone number, wherein the notification includes access information usable by the recipient to redeem the gift;
provide a usage request of the electronic gift from the EGPSM; and
receive an electronic gift usage notification from the EGPSM indicative of usage of the electronic gift tracked by the EGPSM.

8. The device of claim 7, wherein the EGPM is an application on a website.

9. The device of claim 7 wherein the mobile computing device that corresponds to the phone number of the recipient includes an electronic gift receiver module (EGRM) to provide a gift retrieval interface for the recipient to retrieve the electronic gift.

10. The device of claim 9, wherein the gift retrieval interface of the EGRM is to:
display a notification of receipt of the electronic gift purchase on the mobile computing device;
provide a secure login for the recipient, the secure login to authenticate the recipient; and
provide access to the electronic gift sent from the EGPSM subsequent to the authentication the recipient.

11. The device of claim 7, further comprising:
the set of gift data including gift payment type information, wherein the gift payment type information includes one of credit card information and direct phone bill information.

12. A system to purchase an electronic gift from a gift sending device for a recipient via a gift processing server, the system comprising:
a gift sending device that includes an electronic gift phone module (EGPM);
a gift receiving device that includes an electronic gift receiver module (EGRM); and
a gift processing server communicatively coupled to each of the gift sending device and the gift receiving device that includes an electronic gift processing server module (EGPSM);
wherein the EGPM of the gift sending device is to receive a recipient phone number and a set of gift data from a user of the gift sending device and transmit the recipient phone number and the set of gift data received at the gift-sending application to the EGPSM of the gift processing server, the set of gift data includes a type of an electronic gift to purchase from a retail establishment,
wherein the EGPSM of the gift processing server is to receive the recipient phone number and the set of gift data from the gift sending device, communicate with the retail establishment to purchase the electronic gift from the retail establishment utilizing at least the gift identification, and send a notification of the purchase of the electronic gift to the EGRM of the gift receiving device that includes access information usable by the recipient to access the electronic gift,
wherein the EGPSM is further to track a usage of the electronic gift,
wherein the EGPM is further to request the usage of the electronic gift from the EGPSM, and
wherein the EGPM is further to receive an electronic gift usage notification from the EGPSM indicative of the tracked usage of the electronic gift.

13. The system of claim 12, wherein the gift receiving device is capable of communication over a cellular telephony network and identifiable by the recipient phone number.

14. The system of claim 12, wherein the EGRM further includes a gift retrieval interface for the user to retrieve the electronic gift.

15. The system of claim 14, wherein to retrieve the electronic gift comprises to:
provide a secure login for the recipient;
authenticate the recipient of the electronic gift via the secure login; and
provide access to the electronic gift sent from the EGPSM, subsequent to the authentication of the recipient via the secure login.

16. The system of claim 12, wherein the EGPSM is further to send a notification to confirm the purchase of the electronic gift to the EGPM.

17. The system of claim 12, wherein the set of gift data further includes gift payment type information, wherein the gift payment type information includes one of credit card information and direct phone bill information.
